(19) United States
(12) Patent Application Publication
(10) Pub. No.: US 2025/0337825 A1
(43) Pub. Date: Oct. 30, 2025

(54) METHOD AND APPARATUS FOR SUPPORTING MULTI-PATH TRANSMISSION IN WIRELESS COMMUNICATION SYSTEM

(71) Applicant: Samsung Electronics Co., Ltd., Gyeonggi-do (KR)

(72) Inventors: Sunwoo CHO, Gyeonggi-do (KR); Jinho CHOI, Gyeonggi-do (KR); Youngdae KOO, Gyeonggi-do (KR); Jaheon GU, Gyeonggi-do (KR); Dongmyung KIM, Gyeonggi-do (KR); Jeonga LIM, Gyeonggi-do (KR); Jiyoung CHA, Gyeonggi-do (KR)

(21) Appl. No.: 19/174,370

(22) Filed: Apr. 9, 2025

(30) Foreign Application Priority Data
Apr. 24, 2024 (KR) 10-2024-0054592

(51) Int. Cl. H04L 69/322; H04L 65/1066

(52) U.S. Cl. CPC H04L 69/322; H04L 65/1066

(57) ABSTRACT

The present disclosure relates to a 5G communication system or a 6G communication system for supporting higher data rates beyond a 4G communication system such as long term evolution (LTE). A method of a first SMF may include receiving a first message including a multi-generation aggregation (MGA) capability from a first access and mobility management function (AMF) included in the first communication system, discovering a second SMF included in a second communication system in cast that determining that a user equipment (UE) supports MGA, based on the MGA capability, transmitting a second message including the MGA capability and subscription information about the second SMF to the second SMF, receiving, from the second SMF, a third message including information about a packet data unit (PDU) session transmitted from a second user plane function (UPF) included in the second communication system to the second SMF, and generating a PDU session between the UE and the second communication system, based on the third message.

### CROSS-REFERENCE TO RELATED APPLICATION(S)

This application is based on and claims priority under 35 U.S.C. § 119 to Korean Patent Application No. 10-2024-0054592, filed on Apr. 24, 2024, in the Korean Intellectual Property Office, the disclosure of which is incorporated herein by reference in its entirety.

### BACKGROUND

### 1. Field

The disclosure relates generally to a wireless communication system and, more particularly, to a method and an apparatus for providing multi-path transmission in a wireless communication system or a mobile communication system.

### 2. Description of Related Art

Considering the development of wireless communication from generation to generation, the technologies have been developed for services targeting humans, such as, for example, voice calls, multimedia services, and data services. Following the commercialization of 5th-generation (5G) communication systems, the number of connected devices is expected to exponentially grow. Examples of connected things may include vehicles, robots, drones, home appliances, displays, smart sensors connected to various infrastructures, construction machines, and factory equipment. Mobile devices are expected to evolve in various forms, such as, for example, augmented reality glasses, virtual reality headsets, and hologram devices. In order to provide various services by connecting hundreds of billions of devices and things in the 6th-generation (6G) era, there have been ongoing efforts to develop improved 6G communication systems. For these reasons, 6G communication systems are referred to as beyond-5G systems.

6G communication systems may have a peak data rate of tera-level bps and a radio latency less than 100 μsec, and thus will be 50 times as fast as 5G communication systems and have the 1/10 radio latency thereof.

In order to accomplish such a high data rate and an ultra-low latency, it has been considered to implement 6G communication systems in a terahertz band (e.g., 95 GHz to 3 THz bands). It is expected that, due to more severe path loss and atmospheric absorption in the terahertz bands than those in millimeter wave (mm Wave) bands introduced in 5G, technologies capable of securing the signal transmission distance (e.g., coverage) will become more crucial. It is necessary to develop, as major technologies for securing the coverage, radio frequency (RF) elements, antennas, novel waveforms having a better coverage than orthogonal frequency division multiplexing (OFDM), beamforming and massive multiple input multiple output (MIMO), full dimensional MIMO (FD-MIMO), array antennas, and multiantenna transmission technologies such as large-scale antennas. In addition, there has been ongoing discussion on new technologies for improving the coverage of terahertz-band signals, such as metamaterial-based lenses and antennas, orbital angular momentum (OAM), and reconfigurable intelligent surface (RIS).

Moreover, in order to improve the spectral efficiency and the overall network performances, the following technologies have been developed for 6G communication systems: a full-duplex technology for enabling an uplink transmission and a downlink transmission to simultaneously use the same frequency resource at the same time; a network technology for utilizing satellites, high-altitude platform stations (HAPS), and the like in an integrated manner; an improved network structure for supporting mobile base stations and the like and enabling network operation optimization and automation and the like; a dynamic spectrum sharing technology via collision avoidance based on a prediction of spectrum usage; an use of artificial intelligence (AI) in wireless communication for improvement of overall network operation by utilizing AI from a designing phase for developing 6G and internalizing end-to-end AI support functions; and a next-generation distributed computing technology for overcoming the limit of user equipment (UE) computing ability through reachable super-high-performance communication and computing resources (e.g., mobile edge computing (MEC), clouds, and the like) over the network. In addition, through designing new protocols to be used in 6G communication systems, developing mechanisms for implementing a hardware-based security environment and safe use of data, and developing technologies for maintaining privacy, attempts to strengthen the connectivity between devices, optimize the network, promote softwarization of network entities, and increase the openness of wireless communications are continuing.

Research and development of 6G communication systems in hyper-connectivity, including person to machine (P2M) as well as machine to machine (M2M), is expected to allow the next hyper-connected experience. Particularly, services such as truly immersive extended reality (XR), high-fidelity mobile hologram, and digital replica may be expected to be provided through 6G communication systems. In addition, services such as remote surgery for security and reliability enhancement, industrial automation, and emergency response may be provided through the 6G communication system such that the technologies could be applied in various fields such as industry, medical care, automobiles, and home appliances.

As the commercialization of 6G approaches, various methods may be provided for linking 6G with 5G. These options may be aimed at overcoming limitations of a 6G radio access network (RAN), which is expected to have reduced coverage by using a higher frequency band than 5G, by linking with 5G.

### SUMMARY

The disclosure proposes a method in which a legacy generation (LeG) core network (CN) transmits information to a new generation (NewG) CN to preemptively establish a session with a NewG user plane (UP) network function (NF), when a UE, which wants to receive a multi-generation traffic aggregation (multi-generation aggregation (MGA)) service by using the NewG UP NF in an environment where a LeG communication system already commercialized and deployed coexists with a NewG communication system newly introduced and deployed, is present outside NewG coverage.

The method may establish a session with the NewG UP NF before the UE is registered in the NewG CN, to quickly provide a multi-path service by generating a multi-path during the registration in the NewG CN, and to ensure session continuity and stably provide a service because a UP anchor handover, which requires moving a session from a LeG UPF not supporting MGA to the NewG UP NF supporting MGA, does not occur.

According to an embodiment, a method of a first session management function (SMF) may include: receiving a first message including an MGA capability from a first access and mobility management function (AMF) included in a first communication system; discovering a second SMF included in a second communication system when a UE is determined to support MGA based on the MGA capability; transmitting a second message including the MGA capability and subscription information about the second SMF to the second SMF; receiving, from the second SMF, a third message including information about a packet data unit (PDU) session transmitted from a first user plane function (UPF) included in the second communication system to the second SMF; and generating a PDU session between the UE and the second communication system, based on the third message. The MGA capability may be an indication that the UE supports the MGA, which combines signal flows between the first communication system and the second communication system into a signal flow.

According to an embodiment, a method of an SMF may include: receiving a second message including a first message and subscription information about the second SMF from a first SMF included in a first communication system; transmitting, to the first SMF, a third message including information transmitted from a first UPF included in a second communication system to the second SMF; and generating a PDU session between a UE and the second communication system, based on the third message. The first message may be received by the first SMF from a first AMF included in the first communication system.

According to an embodiment, a method of a UE may include: transmitting a message including a MGA capability to a first AMF included in the first communication system; and receiving a message including an MGA indicator from a first RAN included in the first communication system. The MGA capability may be an indication that the UE supports MGA, which combines signal flows between communications of different generations into one signal flow, and the MGA indicator may be an indication that a PDU session supporting the MGA is established for the UE.

According to an embodiment, a first SMF may include: a transceiver; and a controller connected to the transceiver and configured to control the transceiver, wherein the controller may be configured to perform control to: receive a first message including an MGA capability from a first AMF included in the first communication system; discover a second SMF included in a second communication system when a UE is determined to support MGA based on the MGA capability; transmit a second message including the MGA capability and subscription information about the second SMF to the second SMF; receive, from the second SMF, a third message including information about a PDU session transmitted from a first UPF included in the second communication system to the second SMF; and generate a PDU session between the UE and the second communication system, based on the third message, and the MGA capability may be an indication that the UE supports the MGA, which combines signal flows between the first communication system and the second communication system into a signal flow.

According to an embodiment, a second SMF may include: a transceiver; and a controller connected to the transceiver and configured to control the transceiver, wherein the controller may be configured to perform control to: receive a second message including a first message and subscription information about the second SMF from a first SMF included in a first communication system; transmit, to the first SMF, a third message including information transmitted from a first UPF included in the second communication system to the second SMF; and generate a PDU session between a UE and the second communication system, based on the third message, and the first message may be received by the first SMF from a first AMF included in the first communication system.

According to an embodiment, a UE for supporting multi-path transmission using a first communication system and a second communication system may include: a transceiver; and a controller connected to the transceiver and configured to control the transceiver, wherein the controller may be configured to perform control to: transmit a message including an MGA capability to a first AMF included in the first communication system; and receive a message including an MGA indicator from a first RAN included in the first communication system. The MGA capability may be an indication that the UE supports MGA, which combines signal flows between communications of different generations into a signal flow, and the MGA indicator may be an indication that a PDU session supporting the MGA is established for the UE.

When a UE requests generation of a multi-access (MA) PDU session from a first CN, a first SMF may transmit information necessary to generate the session to a second SMF, thereby generating a PDU session with a second UPF without a registration procedure in a second communication system. When transmitting a registration request to a second CN, g a multi-path to a second RAN may be immediately generated during a registration procedure by including information about the PDU session with the second UPF generated through the first CN.

According to an embodiment, an UP anchor handover from a LeG UPF to a NewG UP NF does not occur when a UE moves to NewG coverage and generates an MGA session, thus securing session continuity and providing a service of the NewG UP NF.

According to an embodiment, a path between the NewG UP NF and a NewGRAN may be quickly generated using preset context when the UE enters the NewG coverage, thus quickly providing a service through a multi-path.

### BRIEF DESCRIPTION OF THE DRAWINGS

The above and other aspects, features, and advantages of the disclosure will be more apparent from the following detailed description taken in conjunction with the accompanying drawings, in which:

FIG. 1 is a diagram illustrating the architecture of a mobile communication system, according to an embodiment;

FIG. 2A is a diagram illustrating a 6G standalone (SA) structure with a 6G core, according to an embodiment;

FIG. 2B is a diagram illustrating a 6G SA structure with an evolved 5G core, according to an embodiment;

FIG. 2C is a diagram illustrating a 5G-6G non-standalone (NSA) structure with a 5G core, according to an embodiment;

FIG. 2D is a diagram illustrating the structure of 5G-6G aggregation at a CN, according to an embodiment;

FIG. 3A is a diagram illustrating that a user-plane interface is configured when a UE is outside second coverage, according to an embodiment;

FIG. 3B is a diagram illustrating a process of establishing a PDU session when a UE is outside second coverage, according to an embodiment;

FIG. 3C is a diagram illustrating a process of configuring a multi-path when a UE is within second coverage, according to an embodiment;

FIG. 4A is a diagram illustrating a process in which NFs discover each other with a common network repository function (NRF), according to an embodiment;

FIG. 4B is a diagram illustrating a process in which NFs discover each other with respective NRFs, according to an embodiment;

FIG. 5A is a flowchart illustrating a process of generating an MGA PDU session depending on determination of a network, according to an embodiment;

FIG. 5B is a flowchart illustrating a process of generating an MGA PDU session when a UE requests the session, according to an embodiment;

FIG. 6 is a flowchart illustrating a process of registering a UE in a second CN, according to an embodiment;

FIG. 7 is a flowchart illustrating a process of generating an MGA PDU session through interaction between a first AMF and a second AMF, according to an embodiment;

FIG. 8 is a diagram illustrating a procedure of registering a UE in a second CN through interaction between a first AMF and a second AMF, according to an embodiment;

FIG. 9 is a diagram illustrating the structure of a UE, according to an embodiment;

FIG. 10 is a diagram illustrating the structure of an SMF, according to an embodiment;

FIG. 11 is a diagram illustrating the structure of a network entity, according to an embodiment;

FIG. 12 is a flowchart illustrating a method for generating an MGA PDU session from the perspective of a first SMF, according to an embodiment;

FIG. 13 is a flowchart illustrating a method for generating an MGA PDU session from the perspective of a second SMF, according to an embodiment; and

FIG. 14 is a flowchart illustrating a method for generating an MGA PDU session from the perspective of a UE, according to an embodiment.

### DETAILED DESCRIPTION

In describing the embodiments in the specification, descriptions related to technical contents well-known in the art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Furthermore, the size of each element does not completely reflect the actual size.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference signs indicate the same or like elements.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

The disclosure relates a wireless communication system and, more specifically, to an apparatus and a method for providing multipath transmission in a mobile communication system or wireless communication system.

In the following description, terms referring to signals, terms referring to channels, terms referring to control information, terms referring to network entities, terms referring to device elements, and the like are illustratively used for the sake of descriptive convenience. Therefore, the disclosure is not limited by the terms as described below, and other terms referring to subjects having equivalent technical meanings may be used.

Furthermore, various embodiments of the disclosure will be described using terms used in some communication standards (e.g., the 3rd generation partnership project (3GPP)), but they are for illustrative purposes only. Various embodiments of the disclosure may be easily applied to other communication systems through modifications.

Regarding the terms used herein, a first communication system refers to, for example, a 5G communication system, and a second communication system refers to, for example, a 6G communication system. A first CN refers to, for example, a 5G core network (5GC), and a second CN refers to, for example, a 6G CN.

User location information (ULI) is a group of identities related to the location of a mobile device within a network coverage area. ULI may include a location area identity (LAI), an evolved-universal terrestrial radio access network (E-UTRAN) cell global identifier (ECGI), a tracking area identity (TAI), a routing area identification (RAI), a service area identifier (SAI), and a cell global identity (CGI).

3GPP standards standardize 5G network system architecture and procedures. A mobile network operator may provide various services in a 5G network. To provide each service, the mobile network operator needs to satisfy different service requirements (e.g., a delay time, a communication range, a data rate, a bandwidth, and reliability) for each service. To this end, the mobile network operator may configure a network slice, and may allocate a network resource suitable for a specific service for each network slice or each set of network slices. A network resource may refer to an NF, a logical resource provided by an NF, or radio resource allocation of a base station.

For example, the mobile network operator may configure network slice A to provide a mobile broadband service, network slice B to provide a vehicular communication service, and network slice C to provide an IoT service. That is, in the 5G network, each service may be efficiently provided to a UE through a network slice specialized for a characteristic of the service.

A method of securing a low frequency through spectrum sharing and carrier aggregation based on not only an NSA structure in which a 6G RAN is linked to a 5G core (5GC) and a 5G RAN, but also an SA structure is being considered, and a CN aggregation technique that enables a single UE to use 5G coverage by using both 5G and 6G stacks is also being considered. Among these methods, the CN aggregation option may be a major migration option due to low operational complexity, low correlation with an existing 5G device, and thus, low vendor dependency.

To use CN aggregation between multi-generations, a CN UP NF that provides a CN aggregation function is required. However, a current 5G UPF supports access traffic steering, switching, and splitting (ATSSS) based on multipath TCP (MPTCP)/multipath quick UDP Internet connections (MPQUIC), but MPTCP/MPQUIC lacks the ability to cope with changes in the radio environment, and ATSSS supports only a multi-path between 3GPP and non-3GPP accesses. Further, the 5G UPF is unable to support a function (e.g., explicit congestion notification (ECN) marking for low latency, low loss, and scalable throughput (L4S)) likely to be newly introduced in 6G, and is also unable to utilize algorithms and various functions of a 6G UP NF more improved than those of the 5G UPF, and thus there is a growing need to support the 6G UP NF.

Even though a 6G UP NF with a new feature is used in order to overcome the foregoing disadvantages, a handover to the 6G UP NF is required after disconnecting a session established with the 5G UPF, thus not guaranteeing session continuity. That is, since the 5G UPF does not support a function of generating a multi-path between 3GPP accesses, it is necessary to design a procedure for effectively supporting the 6G UP NF expected to support the function.

However, there is no method for generating a UP path to a network of a different generation by transmitting only information about UP session generation to the network. In addition, registration needs to be completed by separating a registration procedure and a PDU session establishment procedure to generate a PDU session, and thus it is impossible to generate a PDU session in a network in which no UE is registered.

interaction between first and second session management (SM) functions is described below.

In a proposed structure, since a second CP is not available before registered in a second communication system, a second UP may be controlled through a first CP. Since direct control between the second CP and a first RAN is impossible after the second CP is registered in the second communication system, transmission through a first SMF may be needed when control of the first RAN is needed. Accordingly, since the first SMF needs to be aware of a second UP session and the latest status of second NFs that manage the session, the first SMF may subscribe to a second SMF in a subscribe-notify mode, and may receive a notification when an event occurs. Examples of the event may include a situation where a change of the second SMF or second UPF is required and a situation where network-requested (second AMF/second SMF/second PCF-initiated) PDU session modification/release is required for a corresponding PDU session.

Described below are three methods for generating a policy and charging control (PCC) rule for the second UPF.

A first method is using a predefined PCC rule. This method is using a PCC rule predefined in the second SMF, in which the second SMF may configure the PCC rule, based on second SM subscription information obtained and transmitted by a first SMF from a unified data management (UDM), and may transmit the PCC rule to the second UPF.

A second method is using a dynamic PCC rule taken from a first policy control function (PCF). That is, the first SMF requests the first PCF to generate the dynamic PCC rule. Accordingly, when the first PCF generates the dynamic PCC rule and forwards the same to the first SMF, the first SMF may forward the dynamic PCC rule to the second SMF, and the second SMF may forward the dynamic PCC rule to the second UPF. In a single path before registration in a second communication system, the second UPF may not be provided with a specialized service of the second communication system but be provided with only the same service as that of the first UPF, and thus may operate based on the rule generated by the first PCF.

A third method is using a dynamic PCC rule taken by the second PCF. That is, the second SMF may request the second PCF to generate the dynamic PCC rule. Accordingly, when the second PCF generates the dynamic PCC rule and forwards the same to the second SMF, the second SMF may forward the dynamic PCC rule to the second UPF. Since second registration has not been established, the second PCF may generate the PCC rule that may be generated by utilizing only information that the second SMF may provide.

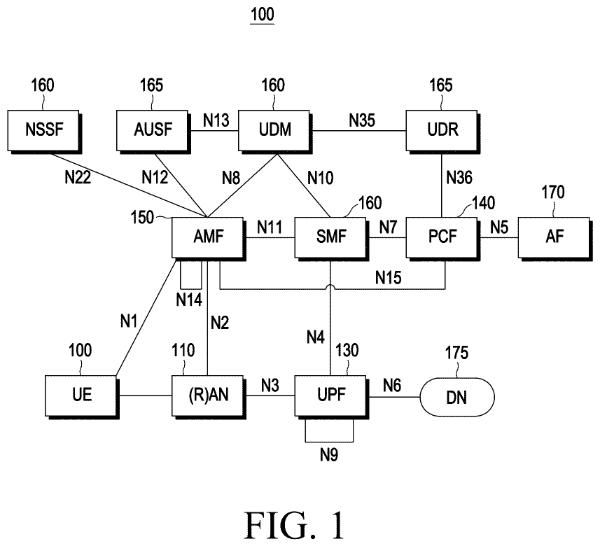

FIG. 1 is a diagram illustrating the architecture of a mobile communication system according to an embodiment.

Referring to FIG. 1, a 5G system (5GS) may include a UE 100, a (R) AN 110, and a 5GC.

The 5GC may include an AMF 120, an SMF 135, a UPF 130, a PCF 140, a UDM 150, a network slice selection function (NSSF) 160, an authentication server function (AUSF) 165, and a unified data repository (UDR) 155. The UE 100 may access the 5GC through the AN 110. Hereinafter, the UE may be referred to as a terminal, and the (R)AN may be referred to as a base station. In addition, the 5GC may further include an application function (AF) 170 and a data network (DN) 175.

The AMF 120 may be an NF that manages radio network access and mobility for the UE 100.

The SMF 135 may be an NF that manages a session for the UE, and session information may include quality-of-service (QoS) information, charging information, and information about packet processing.

The UPF 130 may be an NF that processes user traffic (e.g., user-plane traffic), and may be controlled by the SMF 135.

The PCF 140 may be an NF that manages an operator policy (PLMN policy) for providing a service in a wireless communication system. In addition, the PCF 140 may be divided into a PCF in charge of an access and mobility (AM) policy and a UE policy and a PCF in charge of an SM policy. The PCF in charge of the AM/UE policy and the PCF in charge of the SM policy may be logically or physically separate NFs, or may be logically or physically one NF.

The UDM 150 may be an NF that stores and manages subscriber information about the UE (UE subscription).

The UDR 155 may be an NF or database (DB) that stores and manages data. The UDR 155 may store the subscription information about the UE, and may provide the subscription information about the UE to the UDM 150. Further, the UDR 155 may store operator policy information, and may provide the operator policy information to the PCF 140.

The NSSF 160 may be an NF that performs a function of selecting a network slice instance serving the UE or determining network slice selection assistance information (NSSAI).

The AUSF 165 may be an NF that performs a function of supporting authentication for 3GPP access and non-3GPP access.

The AF 170 may be an NF that provides a function for a service according to the disclosure.

The DN 175 may refer to a data network that may provide an operator service, Internet access, or a third-party service.

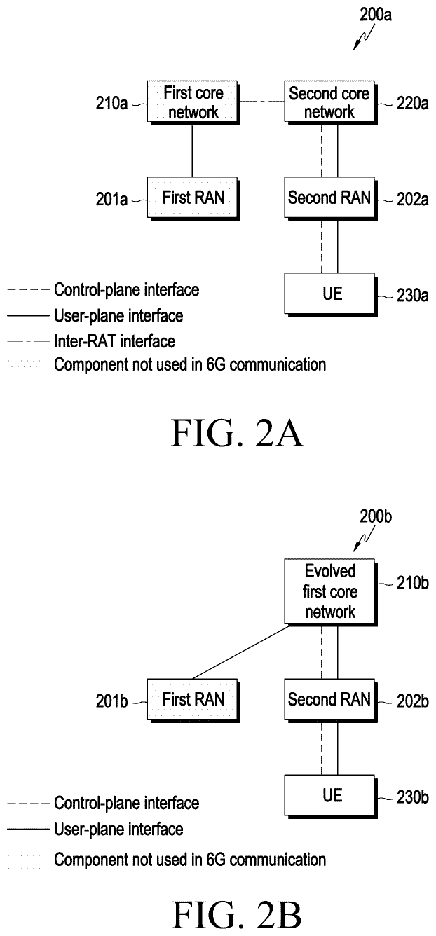

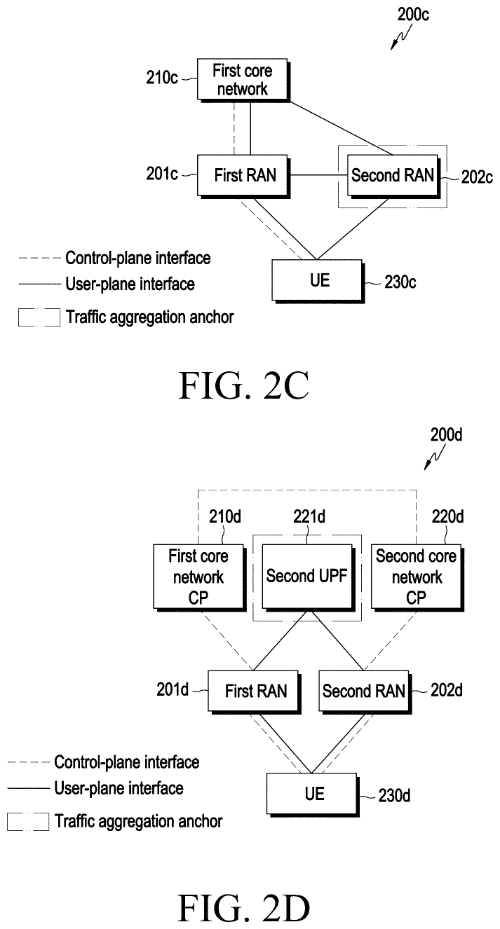

FIG. 2A is a diagram illustrating a 6G SA structure with a 6G core, according to an embodiment. Referring to FIGS. 2A, 2B, 2C, and 2D, options of a structure for migrating to 6G are described in detail. This description is in the direction of minimizing the number of options of the structure in order to prevent unnecessary standardization and market fragmentation and to reduce operational complexity. Although embodiments related to an option illustrated in FIG. 2D are described, the technical idea may also be implemented in relation to options illustrated in FIGS. 2A, 2B, and 2C.

A first CN 210a may be connected to a first RAN 201a through a user-plane interface, and may be connected to a second CN 220a through an inter-radio access technology (RAT) interface. The second CN 220a may be connected to the first CN 210a through the inter-RAT interface, and may be connected to a second RAN 202a through a control-plane interface and a user-plane interface. The second RAN 202a may be connected to the second CN 220a through the control-plane interface and the user-plane interface, and may be connected to a UE 230a through a control-plane interface and a user-plane interface. Multi-RAT spectrum sharing (MRSS) between NR and 6G may also be considered.

This method has flexibility in reorganizing 6G with the simple structure. However, coverage may be insufficient due to the SA structure in the early stage of 6G introduction.

FIG. 2B is a diagram illustrating a 6G SA structure with an evolved 5G core, according to an embodiment.

An evolved first CN 210b may be connected to a first RAN 201b through a user-plane interface, and may be connected to a second RAN 202b through a control-plane interface and a user-plane interface. The second RAN 202b may be connected to the evolved first CN 210b through the control-plane interface and the user-plane interface, and may be connected to a UE 230b through a control-plane interface and a user-plane interface. Among the control-plane interfaces between the evolved first CN 210b and the second RAN 202b, N2 may be conventional N2 or service-based N2.

MRSS between NR and 6G may also be considered.

This method enables reuse of the 5GC with the simple structure. However, the method does not allow a significant end-to-end (E2E) change.

FIG. 2C is a diagram illustrating a 5G-6G NSA structure with a 5G core, according to an embodiment.

A first CN 210c may be connected to a first RAN 201c through a user-plane interface and a control-plane interface, and may be connected to a second RAN 202c through a control-plane interface. The second RAN 202c is a traffic aggregation anchor, and may be connected to the first CN 210c through a user-plane interface, to the first RAN 201c through a user-plane interface, and to a UE 230b through a user-plane interface. The first RAN 202c may be connected to the first CN 210c through the user-plane interface and the control-plane interface, may be connected to the second RAN 201c through the user-plane interface, and may be connected to the UE 230c through a user-plane interface and a control-plane interface.

This connection may be called an aggregation of radio access networks (RANs), such as 5G NSA E-UTRA/NR dual carrier (EN-DC).

This method enables early deployment of a 6G network, and connection of a UE via both 5G and 6G. However, the method may achieve limited benefits of 6G, and has a complicated operation.

FIG. 2D is a diagram illustrating the structure of 5G-6G aggregation at a CN, according to an embodiment.

A first CN CP 210d may be connected to a second CN CP 220d via a control-plane interface, and may be connected to a first RAN 201d via a control-plane interface. The second CN CP 220d may be connected to the first CN CP 210d via the control-plane interface, and may be connected to a second RAN 202d via a control-plane interface. The first RAN 201d may be connected to the first CN CP 210d via the control-plane interface, may be connected to a second UPF 221d via a user-plane interface, and may be connected to a UE 230d via a control-plane interface and a user-plane interface. The second RAN 202d may be connected to the second CN CP 220d through the control-plane interface, may be connected to the second

UPF 221d through a user-plane interface, and may be connected to the UE 230d through a control-plane interface and a user-plane interface. The second UPF 221d may be connected to the first RAN 201d through the user-plane interface, and may be connected to the second RAN 202d through the user-plane interface.

This connection may be referred to as an aggregation of control networks, such as ATSSS using MPTCP/quick UDP Internet connections (QUIC).

This method has interdependence between 5G and 6G lower than that in the embodiment of FIG. 2C. However, actual benefits and performance need to be identified.

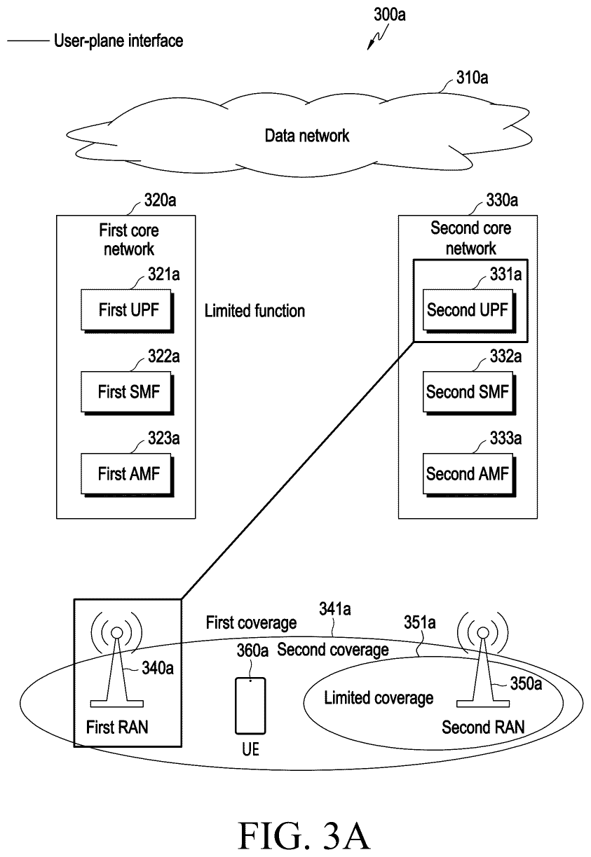

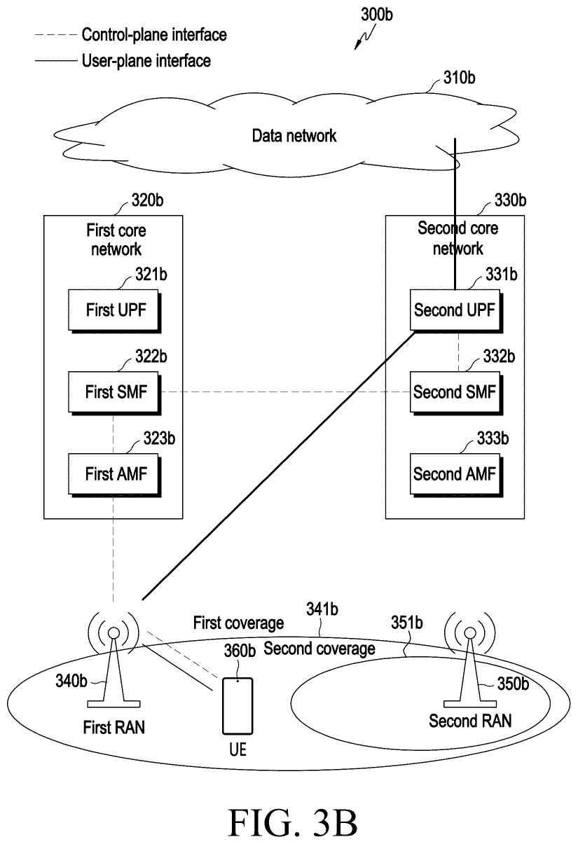

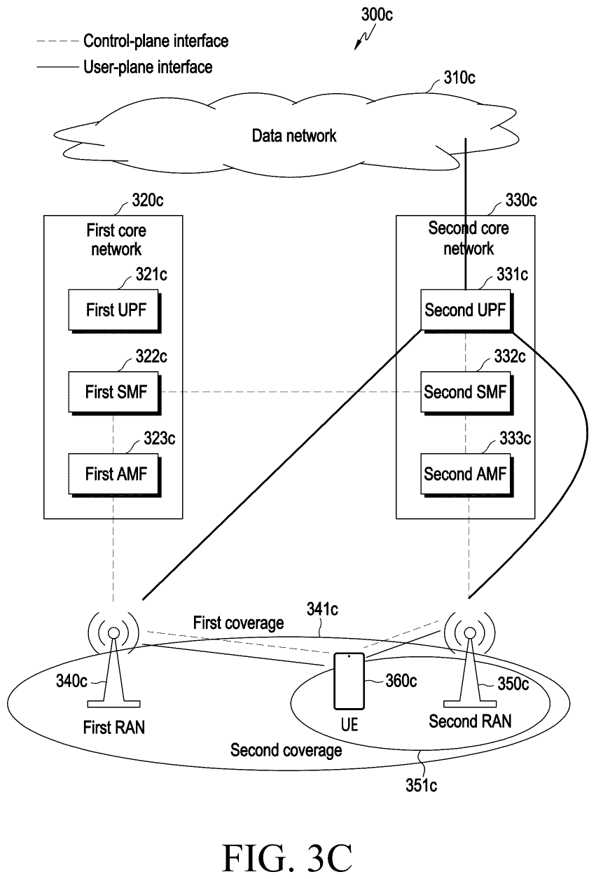

FIG. 3A is a diagram illustrating that a user-plane interface is configured when a UE is outside second coverage, according to an embodiment.

FIG. 3A illustrates part of an embodiment in which the second RAN 202d is connected to the second UPF 221d through the user-plane interface in FIG. 2D.

A first CN 320a may include a first UPF 321a, a first SMF 322a, and a first AMF 323a. A second CN 330a may include a second UPF 331a, a second SMF 332a, and a second AMF 333a. A first RAN 340a may have first coverage 341a, and a UE 360a be included in the first coverage 341a. A second RAN 350a may have second coverage 351a. There may be a data network 310a.

FIG. 3B is a diagram illustrating a process of establishing a PDU session when a UE is outside second coverage, according to an embodiment.

A first CN 320b may include a first UPF 321b, a first SMF 322b, and a first AMF 323b. A second CN 330b may include a second UPF 331b, a second SMF 332b, and a second AMF 333b. A first RAN 340b may have first coverage 341b, and a UE 360b may be included in the first coverage 341b. A second RAN 350b may have second coverage 351b. There may be a data network 310b.

The UE 360b may be connected to the first RAN 340b via at least one of a user-plane interface and a control-plane interface. The first RAN 340b may be connected to the UE 360b via the user-plane interface and the control-plane interface, may be connected to the first AMF 323b via a control-plane interface, and may be connected to the second UPF 331b via a user-plane interface. The first AMF 323b may be connected to the first SMF 322b via a control-plane interface, and may be connected to the first RAN 340b via the control-plane interface. The first SMF 322b may be connected to the first AMF 323b via the control-plane interface, and may be connected to the second SMF 332b via a control-plane interface. (The first CN 320b and the second CN 330b may interact with each other in the control-plane interface connection between the second SMF 332b and the first SMF 332b.) The second SMF may be connected to the first SMF 332b through a control-plane interface, and may be connected to the second UPF 331b through a control-plane interface. The second UPF 331b may be connected to the first RAN 340b through the user-plane interface, may be to the second SMF 332b through the control-plane interface, and may be connected to the data network 310b through a user-plane interface.

The UE 360a is outside the second coverage 351b of the second RAN 350b, and thus may currently not be able to register directly with the second CN 330a. Here, the operation of the first CN 320b is further explained.

When the UE 360b transmits a PDU session establishment request including an MGA capability through the first RAN 340b, the request may be determined as a request to “generate an MGA session using the second UPF 331b”, and the first CN 320b may transmit related information to the second CN 330b when establishing a PDU session, thus generating the session with the second UPF 331b. That is, the session may be generated first using only the second UPF 331b without a procedure of registering with the second CN 330b.

FIG. 3C is a diagram illustrating a process of configuring a multi-path when a UE is within second coverage, according to an embodiment.

FIG. 3C illustrates a process of configuring a multi-path, based on a case where a UE establishes a PDU session with a second UPF when outside second coverage in FIG. 3B, and then enters the second coverage.

A first CN 320c may include a first UPF 321c, a first SMF 322c, and a first AMF 323c. A second CN 330c may include a second UPF 331c, a second SMF 332c, and a second AMF 333c. A first RAN 340c may have first coverage 341c. A second RAN 350c may have second coverage 351c, and a UE 360c may be included in the second coverage 351c. There may be a data network 310c.

The UE 360c may be connected to the first RAN 340c via a user-plane interface and a control-plane interface, and may be connected to the second RAN 350c via a user-plane interface and a control-plane interface. The first RAN 340c may be connected to the UE 360c via the user-plane interface and the control-plane interface, may be connected to the first AMF 323c via a control-plane interface, and may be connected to the second UPF 331c via a user-plane interface. The second RAN 350c may be connected to the UE 360c via the user-plane interface and the control-plane interface, may be connected to the second AMF 333c via a control-plane interface, and may be connected to the second UPF 331c via a user-plane interface. The first AMF 323c may be connected to the first SMF 322c via a control-plane interface, and may be connected to the first RAN 340c via the control-plane interface. The first SMF 322c may be connected to the first AMF 323c via the control-plane interface, and may be connected to the second SMF 332c via a control-plane interface. (The first CN 320c and the second CN 330c interact with each other in the control-plane interface connection between the second SMF and the first SMF 332c.) The second AMF 333c may be connected to the second SMF 332c via a control-plane interface, and may be connected to the second RAN 350c via the control-plane interface. The second SMF 332c may be connected to the first SMF 332c via the control-plane interface, may be connected to the second UPF 331c via a control-plane interface, and may be connected to the second AMF 333c via the control-plane interface. The second UPF 331c may be connected to the first RAN 340c via the user-plane interface, may be connected to the second RAN 350c via the user-plane interface, may be connected to the second SMF 332c via the control-plane interface, and may be connected to the data network 310c via a user-plane interface.

The UE 360c is within the second coverage 351c of the second RAN 350c, and may be able to register directly with the second CN 330c. When PDU session information already generated through the first CN 320c is transmitted, a multi-path may be quickly added using context information already generated during a registration procedure.

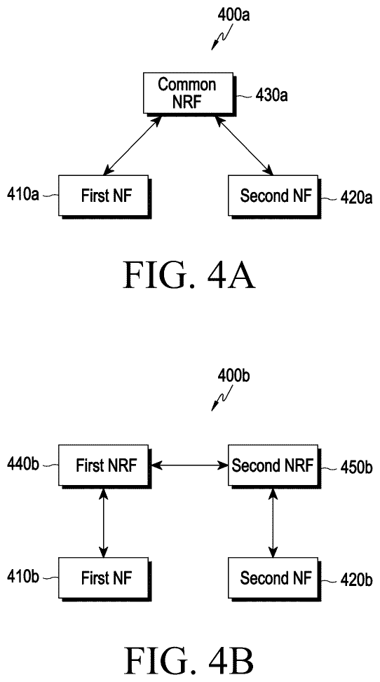

FIG. 4A is a diagram illustrating a process in which a first NF and a second NF discover each other with a common NRF, according to an embodiment.

FIG. 4A and FIG. 4B are diagrams illustrating methods in which a first NF and a second NF discover each other.

The first NF and the second NF may communicate using a service based interface (SBI).

The first (e.g., 5G) NF 410a and the second (e.g., 6G) NF 420a may discover each other as needed. NF discovery may be achieved by registering an NF profile with a common NRF 430a and transmitting a discovery request from the first NF 410a and the second NF 420a to the common NRF 430a.

For the same operator network, first subscriber information and second subscriber information may be stored and managed in a common repository (e.g., a UDR), and the first NF and the second NF may obtain the first/second subscriber information together when necessary.

FIG. 4B is a diagram illustrating a process in which a first NF and a second NF discover each other with respective NRFs according to an embodiment.

Although the first (e.g., 5G) NF 410b may be registered only in a first NRF 440b and transmit a discovery request and the second (e.g., 6G) NF 420b may be registered only in a second NRF 450b and transmit a discovery request, an interface exists between the first NRF 440b and the second NRF 450b so that the discovery requests may be exchanged.

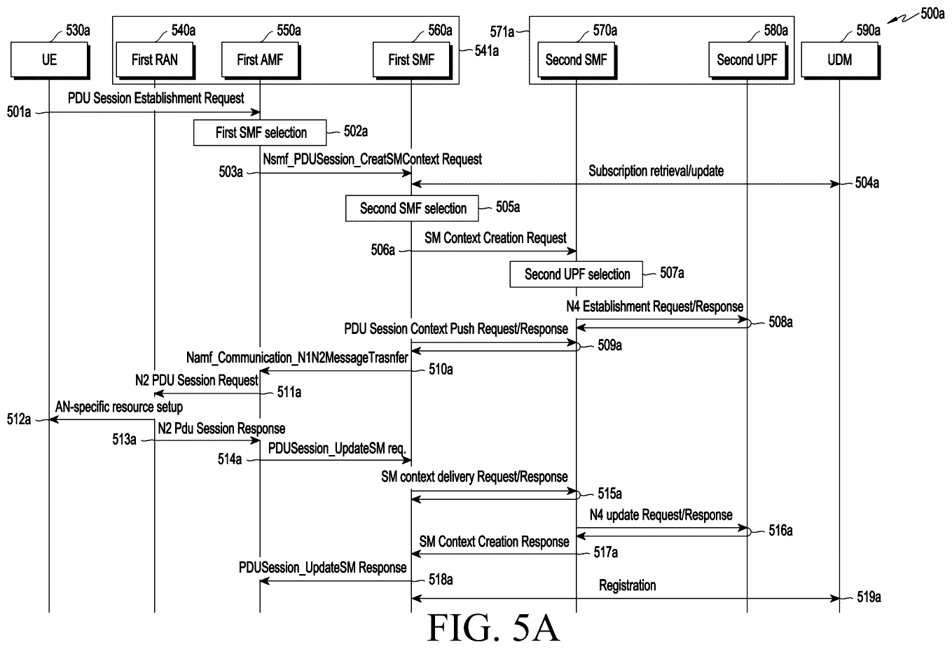

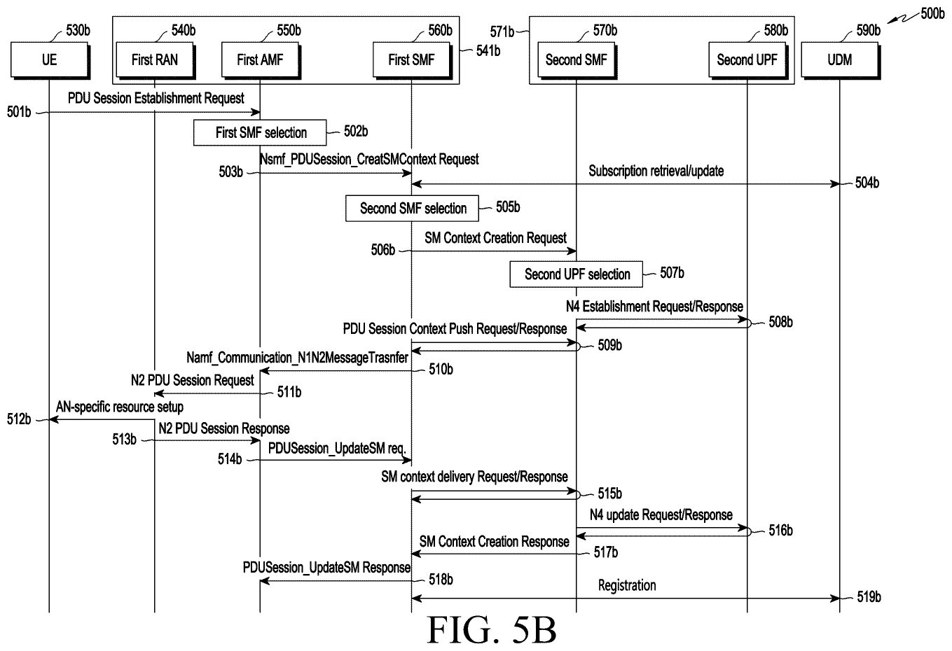

FIG. 5A is a flowchart illustrating a process of generating an MGA PDU session depending on determination of a network, according to an embodiment.

FIG. 5A shows a network-initiated MGA session establishment method in which a network identifies and generates the capability of a UE, and FIG. 5B shows a UE-initiated MGA session establishment method in which a UE requests MGA session generation. An operator may operate a network by selecting one of the two methods.

FIG. 5A is a diagram illustrating a procedure in which when a UE registered in a first CN requests a general PDU session from the first CN, the network determines to generate an MGA PDU session.

Referring to FIG. 5A, a system 500a may include a UE 530a, a first communication system 551a, a second communication system 571a, and a UDM 590a. The first communication system 551a may include a first RAN 540a and a first CN. The first CN may include a first AMF 550a and a first SMF 560a. The second communication system 571a may include a second CN. The second CN may include a second SMF 570a and a second UPF 580a. The UDM 590a may be included in the first CN or the second CN.

The UE 530a may transmit a PDU session establishment request message to the first AMF 550a (501a). The PDU session establishment request message may include an MGA capability indicating that the UE supports MGA in a field.

The first AMF 550a may select the first SMF (502a) and may transmit a Nsmf_PDUSession_CreatSMContext request message to the first SMF (503a).

When identifying that the UE 530a supports the MGA capability, the first SMF 560a may request subscription information from the UDM 590a to retrieve and update SM subscription information about the first communication system (e.g., 5G) 541a and the second communication system (e.g., 6G) 571a (504a).

The first SMF 560a may identify whether the UE is able to use MGA of the second communication system (e.g., 6G) 571a, based on the SM subscription information about the second communication system 571a, may perform a general UE-requested PDU session establishment procedure when the UE 530a is a subscriber unable to use MGA, may discover the second SMF (505a) when the UE 530a is a subscriber able to use MGA, and may transmit SM context including all information included in the Nsmf PDUSession CreatSMContext request message 503a, the SM subscription information about the second communication system 571a, and the MGA capability to the second SMF 570a (506a).

The second SMF 570a may select the second UPF (507a), and may preemptively generate a single path PDU session through the first RAN 540a. When selecting the second UPF 580a (507a), at least one of whether the second UPF 580a supports an MGA function and location information about the UE 530a may be considered. However, when TAI mapping between the first communication system 541a and the second communication system 571a is not possible with respect to ULI, the first AMF 550a may convert a TAI into a geographical location and then transmit the same to the second SMF 570a for use. In addition, the second SMF 570a may transmit a PDU session context push request message to the second UPF 580a to transmit an SM policy and receive a PDU session context push respond message from the second UPF 580a to receive a response (508a), and may transmit generated PDU session information to the first SMF 560a and receive a response from the first SMF 560a (509a). Operation 509a may be the second SMF 570a relaying information transmitted to the second SMF 570a to the first SMF 560a.

The first SMF 560a notifies the UE 530a that an MGA PDU session has been established. This process may be performed by the first SMF 560a adding an MGA indicator (or an MGA indicator to field) an N1 SM container in a Namf_Communication_N1N2MessageTransfer message transmitted to the first AMF 550a and transmitting the message (510a), by the first AMF 550a adding the MGA indicator to an N2 PDU session request transmitted to the first RAN 540a and transmitting the request (511a), and finally by the first RAN 540a transmitting the MGA indicator during AN-specific resource setup with the UE 530a (512a). The MGA indicator may be an indication that a PDU session supporting MGA has been established for the UE.

The first RAN 540a may transmit an N2 PDU session response to the first AMF 550a (513a), and the first AMF 550a may transmit a PDU Session_UpdateSM request to the first SMF 560a (514a). The first SMF 560a relays the information transmitted from the first AMF 550a to the first SMF 560a to the second SMF 570a. The relay may be the first SMF 560a transmitting an SM context delivery request including the information transmitted from the first AMF 550a to the first SMF 560a to the second SMF 570a (515a). Further, the first SMF 560a may receive an SM context delivery response from the second SMF 570a (515a).

The second SMF 570a may transmit an N4 update request to the second UPF 580a, and may receive an N4 update response from the second UPF (516a).

The second SMF 570a may transmit an SM context creation response including an OK response indicating that the session has been successfully generated to the first SMF 560a (517a).

The first SMF 560a may transmit a PDUSession_UpdateSM response to the first AMF (518a).

The first SMF 560a may register a UE serving NF and a session serving NF in the UDM 590a (519a). The UE serving NF may include a first SMF ID, a second SMF ID, and the PDU session serving NF may include the second SMF ID.

FIG. 5B is a flowchart illustrating a process of generating an MGA PDU session when a UE requests the session, according to an embodiment.

A system 500b shows a procedure in which a UE registered in a first CN 551b specifically requests a PDU session supporting MGA from the first CN 551b to generate the same.

Referring to FIG. 5B, the system 500b may include a UE 530b, a first communication system 551b, a second communication system 571b, and a UDM 590b. The first communication system 551a may include a first RAN 540b and a first CN. The first CN may include a first AMF 550b and a first SMF 560b. The second communication system 571a may include a second CN. The second CN may include a second SMF 570b and a second UPF 580b. The UDM 590b may be included in the first CN or the second CN.

The UE 530b may transmit a PDU session establishment request message to the first AMF 550b (501b). The PDU session establishment request message may include an MGA capability indicating that the UE supports MGA and a request type indicating a request for an MGA PDU session in a field.

The first AMF 550b may select the first SMF 560b (502b), and may transmit an Nsmf_PDUSession_CreatSMContext request to the first SMF 560b (503b).

When determining that the UE 530b requests generation of an MGA session by identifying the MGA capability and the request type, the first SMF 560b may request subscription information from the UDM 590b to retrieve and update SM subscription information about the first communication system (e.g., 5G) 541b and the second communication system (e.g., 6G) 571b (504b). The first SMF 560a may identify whether the UE is able to use MGA of the second communication system (e.g., 6G) 571b, based on the SM subscription information about the second communication system 571b, may transmit a response including rejection to the UE 530b when the UE 530b is a subscriber unable to use MGA, may discover the second SMF 570b (505b) when the UE 530b is a subscriber able to use MGA, and may transmit SM context including all information of the Nsmf_PDUSession_CreatSMContext request message 503b, the SM subscription information about the second communication system 571b, and the request type to the second SMF 570b (506b).

The second SMF 570b may select the second UPF 580b (507b), and may preemptively generate a PDU session for a single path through the first RAN 540b. When selecting the second UPF 580b (507b), at least one of whether the second UPF 580b supports an MGA function and location information about the UE 530b may be considered. However, when TAI mapping between the first communication system 541b and the second communication system 571b (e.g., between 5G and 6G) is not possible with respect to ULI, the first AMF 550b may convert a TAI into a geographical location and then transmit the same to the second SMF 570b for use. In addition, the second SMF 570b may transmit a PDU session push request message to the second UPF 580b to request an SM policy and receive a PDU session context push respond from the second UPF 580b to receive a response (508b), and may request generated PDU session information from the first SMF 560b and receive a response from the first SMF 560b (509b). Operation 509b may be relaying information transmitted from the second UPF 580b to the second SMF 570b to the first SMF.

The first SMF 560b may transmit a Namf_Communication_N1N2Messbge Transfer to the first AMF 550b (510b), the first AMF 550b may transmit an N2 PDU session request to the first RAN 540b (511b), and the first RAN 540b may perform AN-specific resource setup with the UE 530b (512b).

The first RAN 540b may transmit an N2 PDU session response to the first AMF 550b (513b), and the first AMF 550b may transmit a PDU Session_UpdateSM request to the first SMF 560b (514b). The first SMF 560b may transmit an SM context delivery request including information transmitted (514b) from the first AMF 550b to the first SMF 560b to the second SMF 570b, and may receive an SM context delivery response from the second SMF 570b (515b).

The second SMF 570b may transmit an N4 update request to the second UPF 580b, and may receive an N4 update response from the second UPF (516b).

The second SMF 570b may transmit an SM context creation response including an OK response indicating that session has been successfully generated to the first SMF 560b (517b).

The first SMF 560b may transmit a PDUSession_UpdateSM response to the first AMF (518b).

The first SMF 560b may register a UE serving NF and a session serving NF in the UDM 590b (519b). The UE serving NF may include a first SMF ID, a second SMF ID, and the PDU session serving NF may include the second SMF ID.

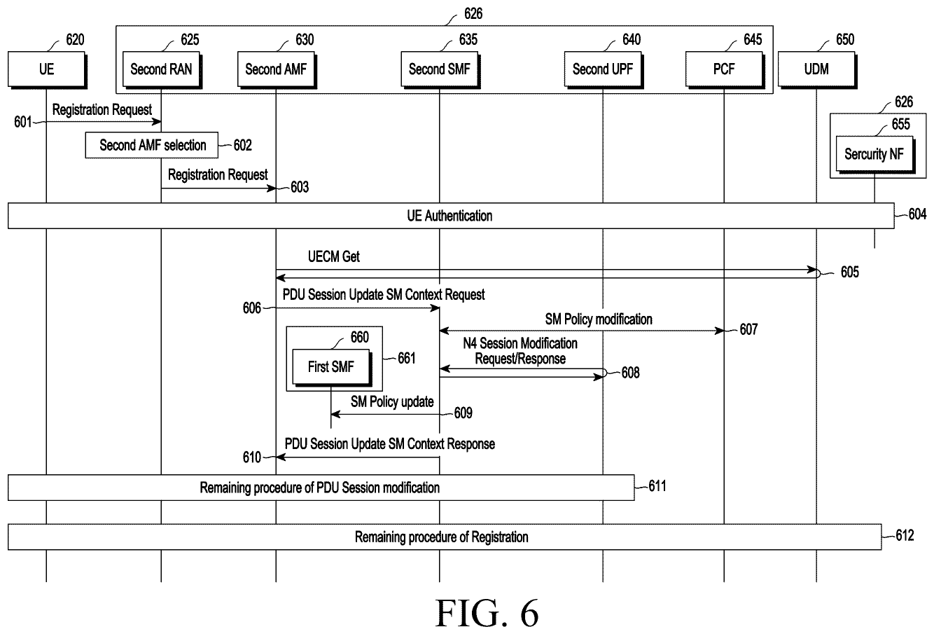

FIG. 6 is a flowchart illustrating a process of registering a UE in a second CN, according to an embodiment.

When a UE 620 having an MGA PDU session with a second UPF 640 through a first CN moves to the coverage of a second communication system (e.g., 6G) 626 and is registered in a second CN, the second CN may generate a multi-path to a second RAN 625 during a registration procedure.

A system 600 shows a procedure in which the UE 620 having the MGA PDU session with the second UPF 640 through the first CN moves to the coverage of the second communication system (e.g., 6G) 626 and is registered in the second CN.

Referring to FIG. 6, the system 600 may include the UE 620, a first communication system 661, the second communication system 626, and a UDM 650. The first communication system 661 may include the first CN, and the second communication system may include the second CN and the second RAN 625. The first CN may include a first SMF 661, and the second CN may include a second AMF 630, a second SMF 635, the second UPF 640, a PCF 645, and a security NF 655. The UDM 650 may be included in the first CN or the second CN.

When the UE 620 currently has an MGA PDU session, the UE 620 may transmit a registration request having an MGA PDU session ID(s) field to the second RAN 625 (601). The MGA PDU session ID(s) field may include a PDU session ID(s) generated in registration with the first communication system. The second RAN 625 may select the second AMF 630 (602). The second RAN 625 may transmit the registration request having the MGA PDU session ID(s) field to the second AMF 630 (603). When an ID exists in the MGA PDU session ID(s) field, the second AMF 630 may determine that an MGA session already exists in the second UPF 640.

The UE 620, the second RAN 625, the second AMF 630, the second SMF 635, the second UPF 640, the PCF 645, the UDM 650, and the security NF655 may perform UE authentication (604).

When the received registration request message includes the MGA PDU session ID(s) field, the second AMF 630 may obtain information about the second SMF 635 providing a service in a corresponding session from the UDM650 by using a UE ID and the MGA PDU Session ID(s) (605). When the second SMF635 providing the service for the UE 620 or the session is not found, the second AMF 630 may transmit a response indicating that the session does not exist to the UE620, and the UE 620 may delete session information. When the second SMF 635 providing the service for the UE 620 or the session is found, the second AMF 630 may transmit an SM context update message including the UE ID, the MGAPDU session ID(s), and the ID of the second RAN 625 to the second SMF 635 (606).

The second SMF 635 and the PCF 645 may modify an SM policy through exchange of at least one message (607). The second SMF 635 may transmit a request for policy modification including a multi-access (MA) PDU request and an MGA capability to the PCF 645, and the PCF 645 may transmit a PCC rule including MA PDU session control information to the second SMF 635.

The second SMF 635 may transmit a request for generation of a multi-path having a tunnel to the second RAN 625 to the second UPF 640 providing the service for the UE 620 with respect to the PDU session of the ID (608). The second SMF 635 may transmit an N4 session modification request including the request for the generation of the multi-path to the second UPF 640. The second UPF 640 may transmit an N4 session modification response message to the second SMF 635 in response to the N4 session modification request.

To transmit updated information about the policy related to the RAN to the first RAN, the second SMF 635 may transmit an updated SM policy to the first SMF 660 (609).

The second SMF 635 may transmit a PDU session update SM context response to the second AMF 630 in response to the SM context update message transmitted in 606 (610).

The UE 620, the second RAN 625, the second AMF 630, the second SMF 635, and the second UPF 640 may perform the remaining procedure of the PDU session modification (611).

The UE 620, the second RAN 625, the second AMF 630, the second SMF 635, the second UPF 640, the PCF 645, and the UDM 650 may perform the remaining procedure of the registration (612).

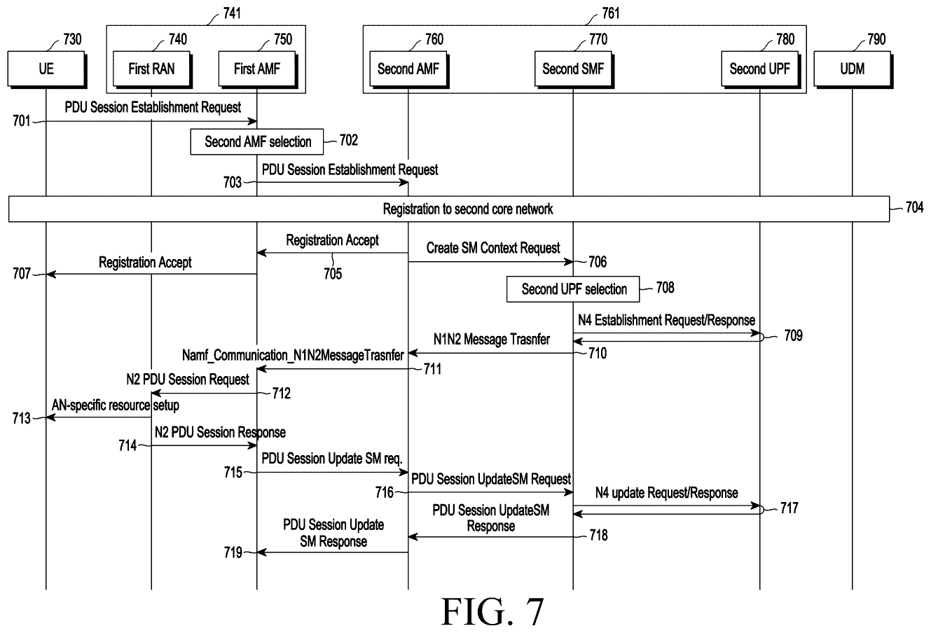

FIG. 7 is a flowchart illustrating a process of generating an MGA PDU session through interaction between a first AMF and a second AMF, according to an embodiment.

FIG. 7 shows a procedure in which when a UE registered in a first CN requests a general PDU session from the first CN, the network determines and generates an MGA PDU session through information exchange between a first AMF 750 and a second AMF 760.

Referring to FIG. 7, a system 700 may include a UE 730, a first communication system 741, a second communication system 761, and a UDM 790. The first communication system 741 may include a first RAN 740 and the first CN, and the second communication system 761 may include a second CN. The first CN may include the first AMF 750, and the second CN may include the second AMF 760, a second SMF 770, and a second UPF 780. The UDM 790 may be included in the first CN or the second CN.

The UE 730 may transmit a PDU session establishment request message to the first AMF 750 by adding an SM capability field, which is an area identifiable by the first AMF 750, to an NAS message of the PDU session establishment request message and indicating an MGA capability therein (701).

The first AMF 750 may identify the field, and may generate an MGA session (select the second AMF). The first AMF 750 may select the second AMF 760 (702), and may transmit context of the UE 730 to the second AMF 760 (703). The first AMF 750 may transmit all context of the UE 730 that the first AMF 750 has and the PDU session establishment request message together (703).

The second AMF 760 registers the UE 730 by using the context of the UE 730 received from the first AMF 750 (704).

When the registration is completed, the second AMF 760 may transmit a registration accept message including the ID of the second AMF to the first AMF 750 (705). The first AMF 750 may transmit the registration accept message including the ID of the second AMF to the UE 730 (707).

The second AMF 760 may transmit the PDU session establishment request (703) received from the first AMF 750 to the second SMF 770 to generate an MGA session (706).

The second SMF 770 may select the second UPF (708). The second SMF 770 may transmit an N4 establishment request to the second UPF 780, and may receive a response from the second UPF 780 (709). The second SMF 770 may transfer an N1N2 message to the second AMF 760 (710). The second AMF 760 may transfer a Namf_Communication_N1N2Message to the first AMF 750 (711). The first AMF 750 may transmit an N2 PDU session request message to the first RAN 740 (712). The first RAN 740 may perform AN-specific resource setup with the UE 730 (713). The first RAN 740 may transmit an N2 PDU session response message to the first AMF 750 (714). The first AMF 750 may transmit a PDU session update SM request message to the second AMF 760 (715). The second AMF 760 may transmit the PDU session update SM request message to the second SMF 770 (716). The second SMF 770 may transmit an N4 update request message to the second UPF 780, and may receive an N4 update response message from the second UPF 780 (717). The second SMF 770 may transmit a PDU session update SM response message to the second AMF 760 (718). The second AMF 760 may transmit the PDU session update SM response message to the first AMF 750 (719).

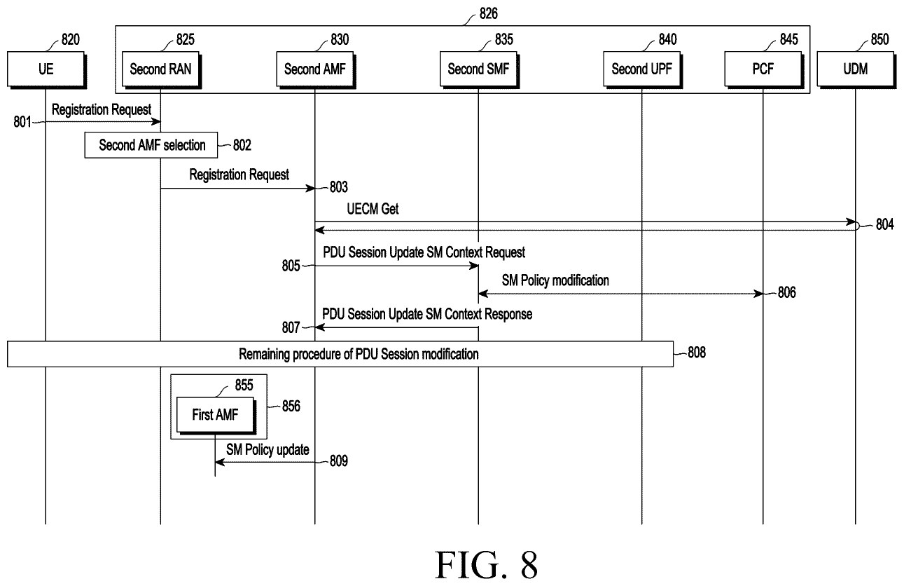

FIG. 8 is a diagram illustrating a procedure in which a UE updates registration in a second CN through interaction between a first AMF and a second AMF, according to an embodiment.

A system 800 shows a procedure in which a UE 820 having an MGA PDU session with a second UPF 840 through a first CN moves to the coverage of a second communication system (e.g., 6G) 826 and is registered in a second CN through interaction between a first AMF 856 and a second AMF 830.

Referring to FIG. 8, the system 800 may include the UE 820, a first communication system 856, the second communication system 826, and a UDM 850. The first communication system 856 includes the first CN, and the second communication system 826 includes a second RAN 825 and the second CN. The first CN may include a first SMF 855, and the second CN may include the second AMF 830, a second SMF 835, the second UPF 840, and a PCF 845. The UDM 850 may be included in the first CN or the second CN.

The UE 820 may transmit a registration update request message to the second RAN 825 (801).

A registration type is a mobility registration update, and a MGA PDU session ID(s) field may include the ID of the second AMF 830 in which the UE 820 has been registered through the first communication system 826 and the ID(s) of an MGA PDU session established with the second UPF 840.

The second RAN 825 may select the second AMF 830 having the ID (802), and may transmit the registration update request message including the MGA PDU session ID(s) thereto (803).

The second AMF 830 may discover the second SMF 835 servicing the session, based on a UE ID and the MGA PDU Session ID(s) (804), and may transmit a PDU session update SM context request to transfer the ID of the second RAN, and may generate an MGA multi-path having a tunnel with the second RAN 825 (805).

The second SMF 835 may modify an SM policy with the PCF 845 (806), and may transmit a PDU session update SM context response to the second AMF 830 in response to operation 805 (807).

The UE 820, the second RAN 825, the second AMF 830, the second SMF 835, and the second UPF 840 may perform the remaining procedure for PDU session modification (808).

The second AMF 830 may transmit policy information to the first AMF 830 to transmit an updated policy related to the RAN to the first RAN (809).

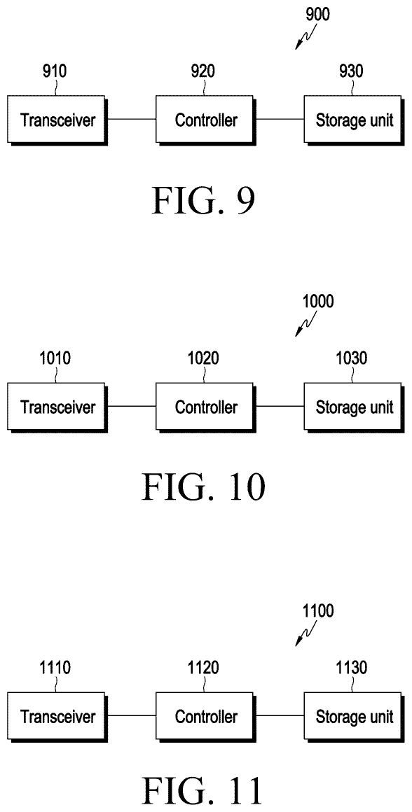

FIG. 9 is a diagram illustrating the structure of a UE, according to an embodiment.

The UE 900 of FIG. 9 may correspond to the UE described with reference to FIG. 1 to FIG. 8.

A transceiver 910, a controller 920, and a storage unit 930 of the UE 900 may operate according to the foregoing communication methods of the UE 900. However, the UE 900 is not limited to the foregoing components. For example, the UE 900 may include more components or fewer components than the foregoing components. The transceiver 910, the controller 920, and the storage unit 930 may be configured as a single chip. The controller 920 may include one or more processors.

The transceiver 910 collectively refers to a receiver of the UE 900 and a transmitter of the UE. 900, and may transmit and receive a signal to and from other devices. To this end, the transceiver 910 may include an RF transmitter that upconverts and amplifies the frequency of a transmitted signal and an RF receiver that performs low-noise amplification of a received signal and down-converts the frequency of the received signal. However, this configuration is only an embodiment of the transceiver 910, and components of the transceiver 910 are not limited to the RF transmitter and the RF receiver. Herein, the transceiver 910 may also be referred to as a transceiver.

The transceiver 910 may receive a signal through a radio channel to output the signal to the controller 920, and may transmit a signal output from the controller 920 through the radio channel.

The storage unit 930 may store a program and data necessary for the operation of the UE 900. The storage unit 930 may also store control information or data included in a signal obtained from the UE 900. The storage unit 930 may be configured as a storage medium, such as read only memory (ROM), random access memory (RAM), a hard disk, compact disc ROM (CD-ROM), and a digital versatile disc (DVD), or a combination of storage media. The storage unit 930 may be configured as being included in the controller 920 instead of existing separately.

The controller 920 may control a series of processes such that the UE 900 may operate according to the foregoing embodiments of the disclosure.

The controller 920 may perform control to transmit a message including at least one of an MGA capability and a request type indicating whether the UE requests a PDU session supporting MGA to a first AMF included in a first communication system.

The MGA capability may be an indication that the UE supports the MGA, which is a service of combining signal flows between communications of different generations into one a signal flow.

FIG. 10 is a diagram illustrating the structure of an SMF, according to an embodiment.

The SMF 1000 may correspond to the first SMF (e.g., any one of 322a of FIG. 3A, 322b of FIG. 3B, 322c of FIG. 3C, 560a of FIG. 5A, 560b of FIG. 5B, and 661 of FIG. 6) belonging to the first communication system or the second SMF (e.g., any one of 332a of FIG. 3A, 332b of FIG. 3B, 332c of FIG. 3C, 570a of FIG. 5A, 570b of FIG. 5B, 635 of FIG. 6, 770 of FIG. 7, and 835 of FIG. 8) belonging to the second communication system which are described with reference to FIG. 1 to FIG. 8. Referring to FIG. 10, the SMF 1000 may include a transceiver 1010, a storage unit 1030, and a controller 1020.

The transceiver 1010, the storage unit 1030, and the controller 1020 of the SMF 1000 may operate according to the foregoing communication methods of the SMF 1000. However, the SMF 1000 is not limited to the foregoing components. For example, the SMF 1000 may include more components or fewer components than the foregoing components. The transceiver 1010, the controller 1020, and the storage unit 1030 may be configured as a single chip. The controller 1020 may include one or more processors.

The transceiver 1010 collectively refers to a receiver of the SMF 1000 and a transmitter of the SMF 1000, and may transmit and receive a signal to and from other devices. To this end, the transceiver 1010 may include an RF transmitter that upconverts and amplifies the frequency of a transmitted signal and an RF receiver that performs low-noise amplification of a received signal and down-converts the frequency of the received signal. However, this configuration is only an embodiment of the transceiver 1010, and components of the transceiver 1010 are not limited to the RF transmitter and the RF receiver. In the disclosure, the transceiver 1010 may also be referred to as a transceiver.

The transceiver 1010 may receive a signal through a radio channel to output the signal to the controller 1020, and may transmit a signal output from the controller 1020 through the radio channel.

The storage unit 1030 may store a program and data necessary for the operation of the SMF 1000. The storage unit 1030 may also store control information or data included in a signal obtained from the SMF 1000. The storage unit 1030 may be configured as a storage medium, such as ROM, RAM, a hard disk, CD-ROM, and a DVD, or a combination of storage media. The storage unit 1030 may be configured as being included in the controller 1020 instead of existing separately.

The controller 1020 may control a series of processes such that the SMF 1000 may operate according to the foregoing embodiments of the disclosure.

The controller 1020 may perform control to receive a first message including an MGA capability from to a first AMF included in a first communication system, to discover a second SMF included in a second communication system when determining that a (UE supports MGA, based on the MGA capability, to transmit a second message including the MGA capability and subscription information about the second SMF to the second SMF, to receive a third message including information about a PDU session, transmitted from a second UPF included in the second communication system to the second SMF, from the second SMF, and to generate a PDU session between the UE and the second communication system, based on the third message.

The controller 1020 may control a series of processes such that the second SMF 1000 may operate according to the foregoing embodiments of the disclosure.

The controller 1020 may perform control to receive a second message including the first message and the subscription information about the second SMF from the first SMF included in the first communication system, to transmit the third message including the information, transmitted from the second UPF included in the second communication system to the second SMF, to the first SMF, and to generate a PDU session between the UE and the second communication system, based on the third message.

FIG. 11 is a diagram illustrating the structure of a network entity, according to an embodiment.

The network entity 1100 of FIG. 11 may correspond to the network entity 1100 described with reference to FIG. 1 to FIG. 8. Referring to FIG. 11, the network entity 1100 may include a transceiver 1110, a storage unit 1130, and a controller 1120.

The transceiver 1110, the storage unit 1130, and the controller 1120 of the network entity 1100 may operate according to the foregoing communication methods of the network entity 1100. However, the network entity 1100 is not limited to the foregoing components. For example, the network entity 1100 may include more components or fewer components than the foregoing components. The transceiver 1110, the controller 1120, and the storage unit 1130 may be configured as a single chip. The controller 1120 may include one or more processors.

The transceiver 1110 collectively refers to a receiver of the network entity 1100 and a transmitter of the network entity 1100, and may transmit and receive a signal to and from other devices. To this end, the transceiver 1110 may include an RF transmitter that upconverts and amplifies the frequency of a transmitted signal and an RF receiver that performs low-noise amplification of a received signal and down-converts the frequency of the received signal. However, this configuration is only an embodiment of the transceiver 1110, and components of the transceiver 1110 are not limited to the RF transmitter and the RF receiver. Herein, the transceiver 1110 may also be referred to as a transceiver.

The transceiver 1110 may receive a signal through a radio channel to output the signal to the controller 1120, and may transmit a signal output from the controller 1120 through the radio channel.

The storage unit 1130 may store a program and data necessary for the operation of the network entity 1100. The storage unit 1130 may also store control information or data included in a signal obtained from the network entity 1100. The storage unit 1130 may be configured as a storage medium, such as ROM, RAM, a hard disk, CD-ROM, and a DVD, or a combination of storage media. The storage unit 1130 may be configured as being included in the controller 1120 instead of existing separately.

Methods described herein may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including a random access memory and a flash memory, a ROM, an electrically erasable programmable read only memory (EEPROM), a magnetic disc storage device, a CD-ROM, DVDs, or other type optical storage devices, or a magnetic cassette. Alternatively, any combination of some or all of them may form a memory in which the program is stored. In addition, a plurality of such memories may be included in the electronic device.

Furthermore, the programs may be stored in an attachable storage device which can access the electronic device through communication networks such as the Internet, Intranet, local area network (LAN), wide LAN (WLAN), and storage area network (SAN) or a combination thereof. Such a storage device may access the electronic device via an external port. Also, a separate storage device on the communication network may access a portable electronic device.

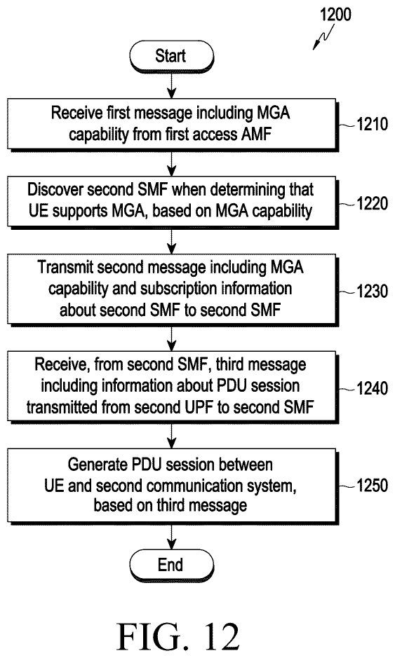

FIG. 12 is a flowchart illustrating a method for generating an MGA PDU session from the perspective of a first SMF, according to an embodiment.

The flowchart includes an operation of receiving a first message including an MGA capability from a first AMF included in the first communication system (1210), an operation of discovering a second SMF included in a second communication system when determining that a UE supports MGA, based on the MGA capability (1220), an operation of transmitting a second message including the MGA capability and subscription information about the second SMF to the second SMF (1230), an operation of receiving, from the second SMF, a third message including information about a PDU session transmitted from a second UPF included in the second communication system to the second SMF (1240), and an operation of generating a PDU session between the UE and the second communication system, based on the third message (1250).

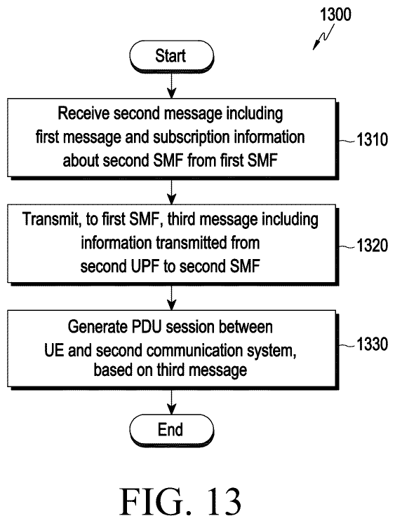

FIG. 13 is a flowchart illustrating a method for generating an MGA PDU session from the perspective of a second SMF, according to an embodiment.

The flowchart includes an operation of receiving a second message including a first message and subscription information about the second SMF from a first SMF included in a first communication system (1310), an operation of transmitting, to the first SMF, a third message including information transmitted from a second UPF included in the second communication system to the second SMF (1320), and an operation of generating a PDU session between a UE and the second communication system, based on the third message (1330).

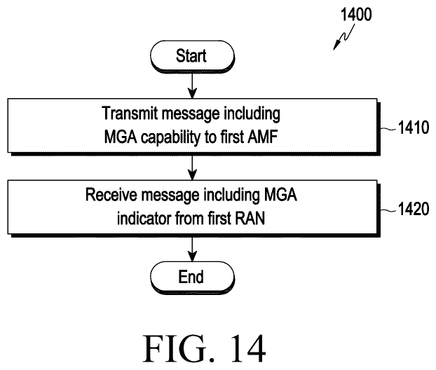

FIG. 14 is a flowchart illustrating a method for generating an MGA PDU session from the perspective of a UE, according to an embodiment.

The flowchart includes an operation of transmitting a message including a MGA capability to a first AMF included in the first communication system (1410) and an operation of receiving a message including an MGA indicator from a first RAN included in the first communication system (1420).

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

Although specific embodiments have been described in the detailed description of the disclosure, it will be apparent that various modifications and changes may be made thereto without departing from the scope of the disclosure. Therefore, the scope of the disclosure should not be defined as being limited to the embodiments set forth herein, but should be defined by the appended claims and equivalents thereof.

What is claimed is:

1. A method of a first session management function (SMF) included in a first communication system for supporting multi-path transmission, the method comprising:
receiving a first message comprising a multi-generation aggregation (MGA) capability from a first access and mobility management function (AMF) included in the first communication system;
discovering a second SMF included in a second communication system in case that a user equipment (UE) is determined to support MGA based on the MGA capability;
transmitting a second message comprising the MGA capability and subscription information about the second SMF to the second SMF;
receiving, from the second SMF, a third message comprising information about a packet data unit (PDU) session transmitted from a first user plane function (UPF) included in the second communication system to the second SMF; and
generating a PDU session between the UE and the second communication system, based on the third message,
wherein the MGA capability is an indication that the UE supports the MGA, which combines signal flows between the first communication system and the second communication system into a signal flow.

2. The method of claim 1, wherein generating the PDU session comprises:
receiving a response that the PDU session is successfully generated from the second SMF; and
registering a first network function (NF) serving the UE and a second NF serving the PDU session in a unified data management (UDM).

3. The method of claim 1, wherein:
the first message further comprises a request type indicating whether the UE requests the PDU session supporting the MGA, and
the second message further comprises the request type.

4. The method of claim 1, wherein a profile of a plurality of NFs is registered by a common network repository function (NRF) for discovering the second SMF.

5. The method of claim 1, further comprising receiving policy-related update information from the second SMF.

6. A method of a second session management function (SMF) included in a second communication system for supporting multi-path transmission, the method comprising:
receiving a second message comprising a first message and subscription information about the second SMF from a first SMF included in a first communication system;
transmitting, to the first SMF, a third message comprising information transmitted from a first user plane function (UPF) included in the second communication system to the second SMF; and
generating a packet data unit (PDU) session between a user equipment (UE) and the second communication system, based on the third message,
wherein the first message is received by the first SMF from a first access and mobility management function (AMF) included in the first communication system.

7. The method of claim 6, wherein generating the PDU session comprises transmitting a response that the PDU session is successfully generated to the first SMF.

8. The method of claim 6, wherein the second message further comprises a request type indicating whether the UE requests the PDU session supporting multi-generation aggregation (MGA), which combines signal flows between communications of different generations into a signal flow.

9. The method of claim 6, further comprising:
receiving a session management (SM) context update message comprising a UE identifier (ID), a second RAN ID, and a PDU session ID from a second access and mobility management function (AMF) included in the second communication system in case that the second SMF serving the UE corresponding to the UE ID or the PDU session corresponding to the PDU session ID is discovered;
modifying an SM policy through a policy control function (PCF) included in the second communication system;
transmitting, to the second UPF, a message for requesting a path having a tunnel with a second radio access network (RAN) included in the second communication system with respect to the PDU session of the PDU session ID; and
transmitting policy-related information to the first SMF.

10. A method of a user equipment (UE) for supporting multi-path transmission using a first communication system and a second communication system, the method comprising:
transmitting a message comprising a multi-generation aggregation (MGA) capability to a first access and mobility management function (AMF) included in the first communication system; and
receiving a message comprising an MGA indicator from a first random access network (RAN) included in the first communication system,
wherein the MGA capability is an indication that the UE supports MGA, which combines signal flows between communications of different generations into a signal flow, and
wherein the MGA indicator is an indication that a packet data unit (PDU) session supporting the MGA is established for the UE.

11. A first session management function (SMF) included in a first communication system for supporting multi-path transmission, the first SMF comprising:
a transceiver; and
a controller connected to the transceiver and configured to control the transceiver,
wherein the controller is configured to perform control to:
receive a first message comprising a multi-generation aggregation (MGA) capability from a first access and mobility management function (AMF) included in the first communication system;
discover a second SMF included in a second communication system in cast that a user equipment (UE) is determined to support MGA based on the MGA capability;
transmit a second message comprising the MGA capability and subscription information about the second SMF to the second SMF;
receive, from the second SMF, a third message comprising information about a packet data unit (PDU) session transmitted from a first user plane function (UPF) included in the second communication system to the second SMF; and
generate a PDU session between the UE and the second communication system, based on the third message,
wherein the MGA capability is an indication that the UE supports the MGA, which combines signal flows between the first communication system and the second communication system into a signal flow.

12. The first SMF of claim 11, wherein the control to generate the PDU session comprises:
controlling to receive a response that the PDU session is successfully generated from the second SMF and
controlling to register a first network function (NF) serving the UE and a second NF serving the PDU session in a unified data management (UDM).

13. The first SMF of claim 11, wherein:
the first message further comprises a request type indicating whether the UE requests the PDU session supporting the MGA, and
the second message further comprises the request type.

14. The first SMF of claim 11, wherein a profile of NFs is registered by a common network repository function (NRF) for discovering the second SMF.

15. The first SMF of claim 11, wherein the controller is configured to further perform control to receive policy-related update information from the second SMF.

16. A second session management function (SMF) included in a second communication system for supporting multi-path transmission, the second SMF comprising:
a transceiver; and
a controller connected to the transceiver and configured to control the transceiver,
wherein the controller is configured to perform control to:
receive a second message comprising a first message and subscription information about the second SMF from a first SMF included in a first communication system;
transmit, to the first SMF, a third message comprising information transmitted from a first user plane function (UPF) included in the second communication system to the second SMF; and
generate a packet data unit (PDU) session between a user equipment (UE) and the second communication system, based on the third message, and
wherein the first message is received by the first SMF from a first access and mobility management function (AMF) included in the first communication system.

17. The second SMF of claim 16, wherein the control to generate the PDU session comprises controlling to transmit a response that the PDU session is successfully generated to the first SMF.

18. The second SMF of claim 16, wherein the second message further comprises a request type indicating whether the UE requests the PDU session supporting multi-generation aggregation (MGA), which combines signal flows between communications of different generations into a signal flow.

19. The second SMF of claim 16, wherein the controller is further configured to perform control to:
receive a session management (SM) context update message comprising a UE identifier (ID), a second RAN ID, and a PDU session ID from a second access and mobility management function (AMF) included in the second communication system in case that the second SMF serving the UE corresponding to the UE ID or the PDU session corresponding to the PDU session ID is discovered;
modify an SM policy through a policy control function (PCF) included in the second communication system;
transmit, to the second UPF, a message for requesting a path having a tunnel with a second radio access network (RAN) included in the second communication system with respect to the PDU session of the PDU session ID; and
transmit policy-related information to the first SMF.

20. A user equipment (UE) for supporting multi-path transmission using a first communication system and a second communication system, the UE comprising:
a transceiver; and
a controller connected to the transceiver and configured to control the transceiver,
wherein the controller is configured to perform control to:
transmit a message comprising a multi-generation aggregation (MGA) capability to a first access and mobility management function (AMF) included in the first communication system; and
receive a message comprising an MGA indicator from a first random access network (RAN) included in the first communication system,
wherein the MGA capability is an indication that the UE supports MGA, which combines signal flows between communications of different generations into a signal flow, and
wherein the MGA indicator is an indication that a packet data unit (PDU) session supporting the MGA is established for the UE.
